(19) United States
(12) Patent Application Publication
(10) Pub. No.: US 2022/0390651 A1
(43) Pub. Date: Dec. 8, 2022

(54) Gradient Index Lens And Method For Producing A Gradient Index Lens

(71) Applicant: Hochschule Rhein-Waal, Kleve (DE)

(72) Inventors: Georg BASTIAN, Kleve (DE); Christoph HESS, Rees (DE)

(21) Appl. No.: 17/761,704

(22) PCT Filed: Sep. 18, 2020
(86) PCT No.: PCT/EP2020/076156

§ 371 Date: Mar. 18, 2022

(30) Foreign Application Priority Data
Sep. 20, 2019 (DE) 10 2019 125 374.8

(51) Int. Cl. G02B 3/00

(52) U.S. Cl. CPC G02B 3/0087; G02B 2003/0093

(57) ABSTRACT

A gradient index lens includes at least one optical material, wherein the optical material has at least two extension axes at an angle relative to one another, wherein the optical material has a refractive index gradient along at least one of the extension axes the optical material, and wherein the optical material is formed to be coiled around at least one of the extension axes.

The invention relates to a gradient index lens and to a method for producing a gradient index lens.

Optical lenses are used for the refraction of light. Conventional lenses consist of an optical material having a particular refractive index and have a curvature. In a conventional lens, an incident light beam is refracted when it enters the shaped lens surface due to the abrupt change in the refractive index from the air to the homogeneous material. The surface shape of the lens determines the focusing and imaging properties of the lens.

An alternative structure of an optical lens known from the prior art is making the refractive index vary radially and not using a curved surface. In recent years, gradient index lens (GRIN lenses) of this kind having a refractive index gradient have found a wide range of applications and are produced on the basis of glass using complex methods. They may have significantly reduced aberrations and, for example, can allow for improved properties e.g. in eyeglasses. In a lens having a refractive index gradient, the refractive index changes continuously within the lens material. In a single GRIN lens plane, optical surfaces can be used. The light beams are continuously curved within the lens. The focusing properties are determined by changing the refractive index within the lens material. In the literature, two types of gradient indices are described: axial gradients and radial/cylindrical gradients. In the axial gradient, the refractive index changes continuously along the optical axis of the inhomogeneous medium. In the axial gradient, the surfaces having a constant index are planes perpendicular to the optical axis. In the radial/cylindrical gradient, the index profile varies continuously from the optical axis to the circumference in the transverse direction, such that the surfaces having a constant index are cylinders concentric with the optical axis.

US 2005/105191 A1 discloses axial, radial, or spherical gradient index lenses, wherein, by forming a set of multilayered polymer composite films consisting of alternating layers A and B, a multilayered composite GRIN film is produced, wherein the gradient index lens is formed by cutting and shaping the multilayered composite GRIN layers.

A drawback of this method known from the prior art is therefore that the refractive index gradient of a GRIN lens known from the prior art is obtained in a complex manner by stacking polymer composite films, which means that the gradient index lenses cannot be produced in a simple manner.

It is also known from the prior art to extrude polymers having several thousand layers in a multilayered manner. This extrusion process is, however, very complex and requires many additional working steps for producing a GRIN lens.

Proceeding from the above-mentioned prior art, the problem addressed by the invention is to provide an improved gradient index lens having any aperture and adjustable refractive index variation, and to provide a method for producing a gradient index lens in which the production of the gradient index lens is simplified.

This problem is solved according to the invention by the features of the independent claims. Advantageous configurations of the invention are found in the dependent claims.

According to the invention, a gradient index lens is thus provided, wherein the gradient index lens comprises at least one optical material, wherein the optical material has at least two extension axes at an angle relative to one another, wherein the optical material has a refractive index gradient along at least one of the extension axes of the optical material, and wherein the optical material is formed to be coiled around at least one of the extension axes.

The basic concept of the present invention is thus to provide a gradient index lens by coiling up an optical material, wherein the optical material has a refractive index gradient along at least one of the extension axes of the optical material.

In particular, the optical material may be an optical material obtained by extrusion and/or by means of coextrusion. The use of extrusion and coextrusion for producing optical materials comes about from the large number of polymers and polymer dopants that can be used to produce polymer materials.

In an advantageous configuration of the invention, the optical material is selected from the group consisting of a polymer material, a composite polymer, a polymer mixture, and/or a polymer compound, with a polymer compound essentially being understood here to be a polymer-based material supplied with additives and/or fillers. In particular, the polymer material, the composite polymer, and/or the polymer mixture may be selected from the group consisting of a polyethylene naphthalate, an isomer thereof, a polyalkylene terephthalate, a polyimide, a polyetherimide, a styrene polymer, a polycarbonate, a poly(meth)acrylate, a cellulose derivative, a polyalkylene polymer, a fluorinated polymer, a chlorinated polymer, a polysulfone, a polyethersulfone, polyacrylonitrile, a polyamide, polyvinyl acetate, a polyether amide, a styrene acrylonitrile copolymer, a styrene ethylene copolymer, poly(ethylene-1,4-cyclohexylenedimethylene terephthalate), an acrylic rubber, isoprene rubber, isobutylene isoprene rubber, butadiene rubber, butadiene-styrene-vinyl pyridine rubber, butyl rubber, polyethylene rubber, chloroprene rubber, epichlorhydrine rubber, ethylene propylene rubber, ethylene propylene diene rubber, nitrile butadiene rubber, polyisoprene rubber, silicone rubber, styrene butadiene rubber, and urethane rubber.

Furthermore, the optical material may contain mixtures of two or more of the above-described polymers or copolymers, with the components of the mixture preferably substantially being miscible such that the transparency of the mixture is not compromised. Preferred polymer materials are a poly(vinylidene fluoride) (PVDF) and copolymers thereof, a poly(methyl methacrylate), a poly(ethylene naphthalate) (PEN), and a polycarbonate. The components that the optical material according to the present invention comprises may contain organic or inorganic materials which are intended to increase or decrease the refractive index of the components, including nanoparticulate materials.

In a more advantageous configuration of the invention, the polymer material, the composite polymer, the polymer mixture, and/or the polymer compound is selected from the group consisting of an amorphous, partially crystalline, or crystalline thermoplastic, thermosetting or elastomer material.

In an advantageous configuration of the invention, the optical material is an extruded film, one of the extension axes of the optical material being a main extension axis of the film. The advantage of films is that, by coiling the films around at least one of the extension axes in a compact manner, gradient index lenses having very fine radial steps in the refractive index gradient can be produced.

In a more advantageous configuration of the invention, the film has a refractive index gradient along the main extension axis of the film.

In an advantageous configuration of the invention, the film has a refractive index gradient substantially orthogonally to the main extension axis of the film.

In a more advantageous configuration of the invention, the optical material is an extruded fiber, one of the extension axes of the optical material being a main extension axis of the fiber and the fiber having a refractive index gradient along the main extension axis of the fiber. Fibers also have the advantage that they can be produced in a simple manner by means of an extrusion or coextrusion process. Different geometric structures could also be produced by means of fibers, depending on how they are coiled up.

In an advantageous configuration of the invention, the refractive index gradient of the optical material is produced by means of epitaxy, ion exchange, diffusion, sol gel, and/or implantation.

In a more advantageous configuration of the invention, the refractive index is lowest in the center of the gradient index lens and increases toward the outer circumference along the coiled optical material.

In an advantageous configuration of the invention, the refractive index is highest in the center of the gradient index lens and decreases toward the outer circumference along the coiled optical material.

The optical properties of the gradient index lenses can be determined by the refractive index gradient being distributed differently along the optical material, meaning that convex or concave gradient index lenses can be produced in a simple manner.

In an advantageous configuration of the invention, the optical material has a thickness of from 5 nm to 1000 μm. In particular, it may be provided that the optical material has a thickness of between 8 μm and 12 μm.

According to the invention, a method for producing a gradient index lens according to any of the preceding claims is also provided, wherein the method comprises the following steps:
producing an optical material, the optical material being produced by means of an extrusion process and having at least two extension axes at an angle relative to one another,
bringing about a refractive index gradient in the optical material along at least one of the extension axes,
coiling up the optical material, the optical material being coiled around at least one of the extension axes,
sintering the optical material.

In an advantageous configuration of the invention, the step of bringing about a refractive index gradient in the optical material along at least one of the extension axes includes the step of bringing about the refractive index gradient during the extrusion process.

In a more advantageous configuration of the invention, the step of bringing about a refractive index gradient in the optical material along at least one of the extension axes is carried out by varying the composition of the optical material during the extrusion process by means of a dosing gradient.

In an advantageous configuration of the invention, the gradient index lens is brought into a particular shape such that its optical properties are specified by a combination of shape and refractive index variation. The gradient index lens may additionally be brought into any desired shape, including but not limited to an axial, radial or spherical shape, in order to form lenses of different shapes, such as flat or spherical lenses.

In the following, the invention will be explained in greater detail on the basis of preferred embodiments with reference to the appended drawings. The features shown can represent an aspect of the invention both individually and in combination. Features of different embodiments can be transferred from one embodiment to another.

In the drawings:

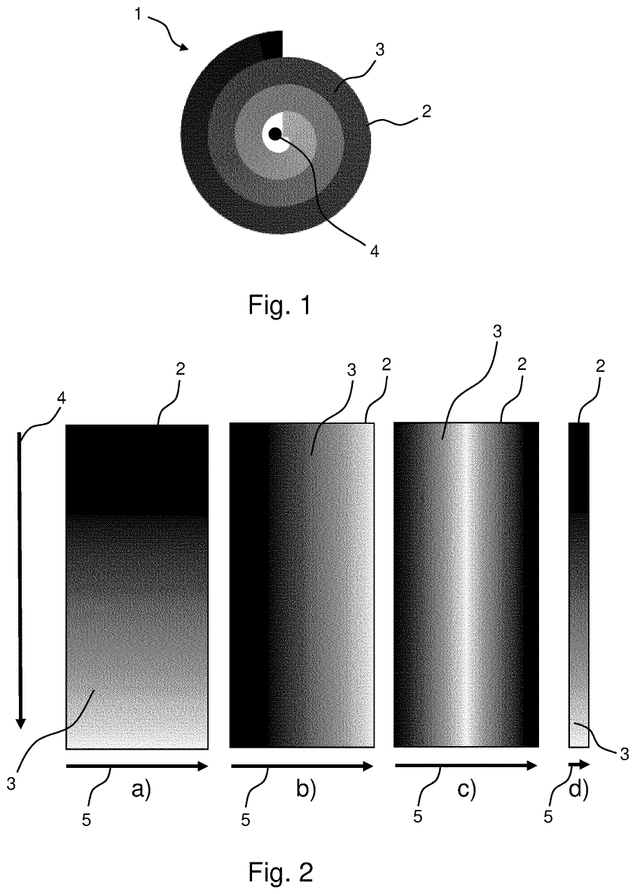

FIG. 1 is a schematic view of a gradient index lens according to an embodiment of the invention;

FIG. 2 shows schematic views of an optical material according to some embodiments of the invention; and

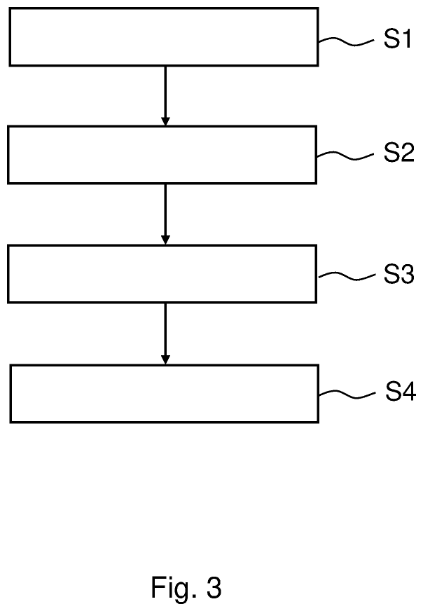

FIG. 3 is a flow diagram of a method for producing a gradient index lens according to an embodiment of the invention.

FIG. 1 is a schematic view of a gradient index lens 1 according to an embodiment of the invention. The gradient index lens 1 shown in FIG. 1 comprises an optical material 2, wherein the optical material 2 has a refractive index gradient 3 along at least one of its extension axes 4, 5. FIG. 1 shows that the optical material 2 is coiled around one of its extension axes 4, 5. If the optical material 2 is a film or a thread, for example, the optical material 2 has a main extension axis 4. In the embodiment of the invention shown in FIG. 1, the optical material 2 is coiled around an extension axis 5 which is substantially orthogonal to the main extension axis 4. The gradient index lens 1 is produced by coiling up the film or fiber. Because the optical material 2 is coiled up, a refractive index gradient 3 along the radius of the thus resulting gradient index lens 1 results from the refractive index gradient 3 along the main extension axis 4 of the optical material 5, for example. FIG. 1 shows that the refractive index gradient 3 of the optical material 2 is lowest in the center of the gradient index lens 1 and increases toward the outer circumference of the gradient index lens 1 along the coiled optical material 2. It may also be provided that the refractive index is highest in the center of the gradient index lens 1 and decreases toward the outer circumference along the coiled optical material 2. The optical properties of the gradient index lenses 1 can be determined by the refractive index gradient 3 being distributed differently along the optical material 2, meaning that convex or concave gradient index lenses 1 can be produced in a simple manner.

A wide range of thermoplastic polymer materials can be used as the optical material 2 in order to form the gradient index lens 1 of the present invention. The optical material 2 may also comprise composite polymers or polymer mixtures. In particular, those materials can be provided which can be produced by means of an extrusion process and can be fixed to form a continuous film. These materials include, inter alia, thermoplastic, or thermosetting processable amorphous, partially crystalline, or crystalline polymer materials and elastomers, provided that the films or threads formed by these materials are substantially transparent to a certain wavelength of electromagnetic radiation. In this case, it may in particular be provided that the optical material 2 is not only transparent to electromagnetic radiation in the optical range, but also in the infrared or terahertz spectrum.

By contrast with conventional methods for producing a gradient index lens 1, it is possible according to the present invention to produce a gradient index lens 1 having significantly greater refractive index gradients 3. This allows a wider range of lenses to be produced. It allows both thin as well as thick and light lenses to be produced. In addition, there is no practical limit on the lens diameter. The diameter according to the present invention can be from 0.1 μm to many meters. This means that large, rapid GRIN lenses having a low aperture number and significantly improved light distribution can be produced.

Furthermore, the refractive index gradient 3 can be easily defined in the optical medium 2 according to the present invention during production. As a result, more complex lenses having improved aberration correction are possible.

FIG. 2 shows schematic views of an optical material 2 according to some embodiments of the invention. A wide range of thermoplastic polymer materials can be used as the optical material 2. The optical material 2 may also comprise composite polymers or polymer mixtures.

FIG. 2 a) shows the optical material 2 in the form of a film. The film can be produced by means of an extrusion process, for example by means of a blown-film extrusion process or a flat-film extrusion process. During the extrusion process, it is in particular provided that a refractive index gradient 3 is brought about in the optical material. This can be carried out by means of epitaxy, ion exchange, diffusion, and/or implantation, for example. In particular, the refractive index gradient 3 is brought about in the optical material 2 by varying the composition of the optical material 2 during the extrusion process. For example, the composition of the optical material 2 can be changed over a defined time period and a refractive index gradient 3 can thus be brought about in the optical material 2 in particular by means of a dosing gradient.

FIG. 2 a) also shows that the film has a refractive index gradient 3 along the main extension axis 4 of the film. The refractive index gradient 3 may be implemented to be continuous, discrete, or stepped in the axial, radial, or spherical direction of the optical material. The refractive index gradient 3 does not have to be monotonic. The additional control by means of the type of refractive index gradient 3 allows considerably more gradient index lenses 1 with e.g. aberration corrections, bifocal and multifocal points and a larger field of view to be produced.

The film shown in FIG. 2 b), as another embodiment of the invention, has a refractive index gradient 3 which extends along an extension axis 5 that is substantially orthogonal to the main extension axis 4.

FIG. 2 c) shows a refractive index gradient 3 which runs along the extension axis 5 from a high refractive index, through a low refractive index, back to a high refractive index.

FIG. 2 d) shows the optical material in the form of a thread, with the thread shown in FIG. 2 d) having a refractive index gradient 3 along the main extension axis 4 of the thread. Threads have the advantage that they can be brought into various three-dimensional shapes in a simple manner by being coiled up.

By means of the present invention, a high degree of variation in the refractive index gradient 3 can be achieved, with refractive indices in particular of from 1.01 to 1.8, but also up to a value of almost 2, being possible. Since the refractive index gradient 3 can be dynamically varied, the focal lengths of the gradient index lenses produced from these materials can be varied. This makes it possible, for example, to construct objectives having a variable focal length and zoom objectives without movable parts.

FIG. 3 is a flow diagram of a method for producing a gradient index lens 1 according to an embodiment of the invention. The method starts with step S1. According to an embodiment of the present invention, the optical material 2 is first produced in step S1. In this embodiment of the present invention, the optical material 2 may for example be a glass-like polymer material, a crystalline polymer material, an elastomer polymer material, or a mixture thereof. In the above-described embodiment of a polymer structure, the optical material 2 can in particular be produced by coextruding the polymer material. The optical material 2 can also be produced by means of an extrusion process. By producing the optical material 2 using an extruder, the optical material 2 can be brought into the required shape in a simple manner. In particular, it may be provided that the optical material 2 has already been produced in the form of a film or a thread, for example. A blown-film extrusion process or a flat-film extrusion process can in particular also be used for producing films. Depending on the intended purpose of the gradient index lens 1, the optical material 2 can have a thickness of from 5 nm to 1000 μm, for example. In particular, the optical material 2 has a thickness of between 8 μm and 12 μm.

In step S2, a refractive index gradient 3 is brought about in the optical material 2 along at least one of the extension axes 4, 5. In this case, it may in particular be provided that the refractive index gradient 3 has already been brought about in the optical material 2 during the production of the optical material 2. This may for example be carried out by the composition of the optical material 2 being changed over a defined time period during the production process and a refractive index gradient 3 thus being brought about in the optical material 2. A refractive index gradient 3 can also be introduced into the optical material 2 by means of a dosing gradient.

In the subsequent step S3, the optical material 2 provided with a refractive index gradient 3 is coiled up. It may in particular be provided that the optical material 2 is coiled around at least one of its extension axes 4, 5. It is advantageous here that the size of the gradient index lens 1 can be determined in a simple manner by the number of coils of the optical material 2. In addition, in the technique according to the present invention, a significantly larger refractive index gradient 3 can be achieved than in other GRIN manufacturing techniques.

In step S4, the optical material is sintered in order to obtain a durable gradient index lens from the optical material.

### LIST OF REFERENCE SIGNS

1 gradient index lens
2 optical material
3 refractive index gradient
4 main extension axis
5 extension axis
S1 producing an optical material
S2 introducing a refractive index gradient
S3 coiling up the optical material
S4 sintering the optical material

1. A gradient index lens, wherein the gradient index lens comprises at least one optical material, wherein the optical material has at least a first extension axis and a second extension axis, the first extension axis being a main extension axis of the optical material and the second extension axis being substantially orthogonal to the main extension axis, wherein the optical material has a refractive index gradient along at least one of the extension axes of the optical material, and the optical material is formed to be coiled around the second extension axis (5) of the optical material.

2. The gradient index lens according to claim 1, wherein the optical material is selected from the group consisting of a polymer material, a composite polymer, a polymer mixture, and a polymer compound.

3. The gradient index lens according to claim 2, wherein the group consisting of the polymer material, the composite polymer, the polymer mixture, and the polymer compound is selected from the group consisting of an amorphous, partially crystalline, or crystalline thermoplastic, thermosetting or elastomer material.

4. The gradient index lens according to claim 1, wherein the optical material is an extruded film, the first extension axis of the optical material being the main extension axis of the film.

5. The gradient index lens according to claim 4, wherein the film has a refractive index gradient along the main extension axis of the film.

6. The gradient index lens according to claim 4, wherein the film has a refractive index gradient substantially orthogonally to the main extension axis of the film.

7. The gradient index lens according to claim 1, wherein the optical material is an extruded fiber, the first extension axis of the optical material being the main extension axis of the fiber and the fiber having a refractive index gradient along the main extension axis of the fiber.

8. The gradient index lens according to claim 1, wherein the refractive index gradient of the optical material is produced by means of epitaxy, ion exchange, diffusion, sol gel, or implantation.

9. The gradient index lens according to claim 1, wherein the refractive index is lowest in the center of the gradient index lens and increases toward the outer circumference along the coiled optical material.

10. The gradient index lens according to claim 1, wherein the refractive index is highest in the center of the gradient index lens and decreases toward the outer circumference along the coiled optical material.

11. The gradient index lens according to claim 1, wherein the optical material has a thickness of from 5 nm to 1000 μm.

12. A method producing a gradient index lens according to claim 1, wherein the method comprises the following steps:
producing an optical material, the optical material being produced by means of an extrusion process and has at least a first extension axis and a second extension axis, wherein the first extension axis is a main extension axis of the optical material and the second extension axis is orthogonal to the main extension axis (4),
bringing about a refractive index gradient in the optical material along at least one of the extension axes,
coiling up the optical material, the optical material being coiled around the second extension axis of the optical material,
sintering the optical material.

13. The method according to claim 12, wherein the step of bringing about a refractive index gradient in the optical material along at least one of the extension axes includes the step of bringing about the refractive index gradient during the extrusion process.

14. The method according to claim 13, wherein the step of bringing about a refractive index gradient in the optical material along at least one of the extension axes is carried out by varying the composition of the optical material during the extrusion process by means of a dosing gradient.

15. The method according to claim 12, wherein the gradient index lens is brought into a particular shape such that its optical properties are specified by a combination of shape and refractive index variation.
